(19) United States
(12) Patent Application Publication
(10) Pub. No.: US 2026/0147398 A1
(43) Pub. Date: May 28, 2026

(54) METHODS AND SYSTEMS FOR MANAGING THERMAL EFFICIENCY

(71) Applicant: Comcast Cable Communications, LLC, Philadelphia, PA (US)

(72) Inventor: Ivan Ong, Philadelphia, PA (US)

(21) Appl. No.: 18/957,205

(22) Filed: Nov. 22, 2024

(51) Int. Cl. G06F 1/3206; G06F 1/20

(52) U.S. Cl. CPC G06F 1/3206; G06F 1/206

(57) ABSTRACT

Methods, apparatuses, and systems are described for managing thermal efficiency of a network device. A power consumption table may be used to determine configurations of a set of parameters for achieving different power consumption levels for the network device. The network device may establish a network connection with a user device according to a first configuration of the set of parameters that achieves a first power consumption level. Based on a temperature of the network device exceeding a threshold based on the first network connection, the network device may determine a second power consumption level that is lower than the first power consumption level. The network device may consult the power consumption table to determine a second configuration of the set of parameters that achieves the second power consumption level and establish a second network connection with the user device according to the second configuration.

### BACKGROUND

As the technology of Wi-Fi gateway routers have evolved, newer Wi-Fi standards with higher throughput capacity have been introduced. As such, the Modulation Coding Scheme continues to increase (e.g., 802.11be supports MCS13), which translates to higher modulation rates being introduced (e.g., 802.11be supports 4k QAM). This has resulted in higher throughput (e.g., 802.11be supports higher PHY rates up to 11 Gps). However, the higher throughput capacity correlates to an increase in power consumption by the integrated circuity components and higher thermal characteristics of the Wi-Fi gateway router. Specifically, as the Wi-Fi gateway routers transmit/receive data via higher throughput according to newer Wi-Fi standards, the components of the Wi-Fi gateway routers such as the Front End Module (FEM), Low Noise Amplifier (LNA), System on Chip (SoC), etc. will rapidly increase in temperature, and thus, contribute to the overall system temperature limits as a whole. As temperatures rise, the fan of the Wi-Fi gateway routers will turn on and RPM will increase to enable airflow. However, the temperatures may continue to rise beyond the capability of the fan and the components of the Wi-Fi gateway routers will begin to shut down. These Wi-Fi gateway routers may also implement heatsinks to help dissipate heat and prevent the temperatures of the Wi-Fi gateway routers from rising. However, the heatsinks occupy much needed design space of the Wi-Fi gateway routers, especially since these heatsinks require large thermal fins to effectively dissipate heat.

### SUMMARY

It is to be understood that both the following general description and the following detailed description are examples and explanatory only and are not restrictive. Methods, systems, and apparatuses for managing thermal efficiency of a network device are described.

A power consumption table may be used to provide configurations of a set of parameters for a network device. The network device may determine a configuration of the set of parameters that achieves a power consumption level. The network device may establish a first network connection with a user device according to a first configuration of the set of parameters that achieves a first power consumption level associated with the network device. Based on a temperature of the network device exceeding a threshold based on the first network connection, the network device may step down the power consumption level associated with the network device by determining a second power consumption level that is lower than the first power consumption level. The network device may access the power consumption table to determine a second configuration of the set of parameters that achieves the second power consumption level and establish a second network connection with the user device according to the second configuration of the set of parameters.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system;

FIG. 2 shows an example system;

FIGS. 3A-3D show an example power consumption table;

FIG. 4 shows an example scenario;

FIG. 5 shows an example scenario;

FIG. 6 shows a flowchart of an example method;

FIG. 7 shows a flowchart of an example method;

FIG. 8 shows a flowchart of an example method;

FIG. 9 shows a flowchart of an example method;

FIG. 10 shows a flowchart of an example method; and

FIG. 11 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

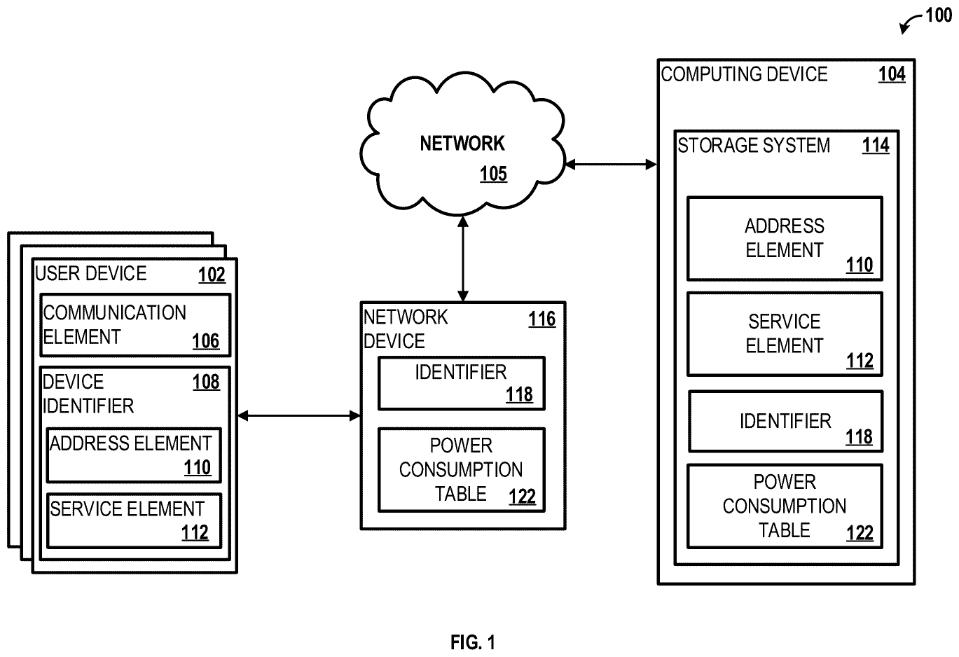

FIG. 1 shows an example system 100 for managing thermal efficiency of a network device (e.g., network device 116). For example, the network device may use a power consumption table to determine a configuration of a set of parameters to achieve a power consumption level in order to control the temperature of the network device. The network and system 100 may be configured to provide services, such as network-related services, to one or more devices (e.g., devices 102). The system 100 may comprise one or more devices 102, a network device 116, and/or a computing device 104. The one or more devices 102 may be in communication with a network device 116, such as a wireless access point (e.g., gateway device) and/or a LTE back-up device, for example. The computing device 104 may be disposed locally or remotely relative to the devices 102. The network device 116 may facilitate access to the network 105 for the devices 102 and/or the computing device 104. For example, the devices 102 and the computing device 104 may be in communication via a private and/or public network 105 such as the Internet or a local area network (LAN) via the network device 116. The network device 116 may be in communication with a computing device 104 such as a centralized device or a server, for example. Other forms of communications can be used such as wired and wireless telecommunication channels.

The devices 102 may comprise electronic devices such as a computer, a smartphone, a laptop, a tablet, a set top box, a display device, a printer, a telephone, a network device, a communication terminal, a transmitter, or other device capable of communicating with the network device 116. As an example, the devices 102 may comprise communication elements 106 for offering an interface to a user to interact with the devices 102 and/or the computing device 104. The communication elements 106 can be any interface for presenting and/or receiving information to/from the user, such as media content. An example interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the devices 102 and the network device 116. As an example, the communication elements 106 can request or query various files from a local source and/or a remote source. As an example, the communication elements 106 can transmit data to a local or remote device such as the network device 116 or the computing device 104 via the network device 116.

The devices 102 may be associated with user identifiers or device identifiers 108. As an example, the device identifiers 108 may be any identifier, token, character, string, or the like, for differentiating one user or user device (e.g., one of the devices 102) from another user or user device. The device identifier 108 may identify a user or user device as belonging to a particular class of users or user devices. As an example, the device identifiers 108 may comprise information relating to the devices 102 such as a manufacturer, a model or type of device, a service provider associated with the devices 102, a state of the devices 102, a locator, and/or a label or classifier. Other information can be represented by the device identifiers 108.

The device identifiers 108 may comprise address elements 110 and service elements 112. The address elements 110 may comprise or make available an internet protocol address, a network address, a media access control (MAC) address, an Internet address, or the like. As an example, the address elements 110 may be relied upon to establish a communication session between the devices 102 and the network device 116 or other devices and/or networks. As an example, the address elements 110 may be used as an identifier or locator of the user devices 102. The address elements 110 may be persistent for a particular network.

The service elements 112 may comprise identification of the service providers associated with the devices 102 and/or with a class of the devices 102. The class of the devices 102 may be related to a type of device, a capability of a device, a type of service being offered, and/or a level of service (e.g., a business class, a service tier, a service package, etc.). As an example, the service elements 112 may comprise information relating to or made available by a communication service provider (e.g., an Internet service provider) that is offering or enabling data flow such as communication services to the devices 102. As an example, the service elements 112 may comprise information relating to a preferred service provider for one or more particular services relating to the devices 102. The address elements 110 may be used to identify or retrieve data from the service elements 112, or vice-versa. As an example, one or more of the address elements 110 and the service elements 112 can be stored remotely from the devices 102 and retrieved by one or more devices such as the devices 102 and the computing device 104. Other information can be represented by the service element 112.

The network device 116 may be in communication with a network, such as network 105. The network device 116 may be configured to allow one or more wireless devices to connect to a wired and/or wireless network using Wi-Fi, Bluetooth®, Zigbee®, or any desired method or standard. As an example, the network device 116 may be configured to facilitate the connection of a device, such as at least one of the devices 102, to the network 105. The network device 116 may be configured as one or more of a set top box, a wireless access point (WAP), a gateway device, a combination thereof, or any device capable of providing content to a display device (e.g., devices 102). In an example, the network device 116 may be configured as a set top box configured to output content items to a display device (e.g., devices 102). In an example, the network device 116 may be configured as a WAP to provide access to a wide area network (e.g., the Internet). For example, the network device 116 may be configured to access the wide area network via a computing device (e.g., computing device 104, server, headend, Internet service provider, etc.). In an example, the network device 116 may be configured to perform one or more gateway functions in order to provide the access to the wide area network. The one or more gateway functions may comprise one or more of network traffic routing, dynamic host configuration protocol (DHCP) management, VoIP functions, or IP streaming functions. In an example, the network device 116 may be configured as a local network (e.g., local area network (LAN)) to provide, to the devices 102 access to the wide area network via the local network.

The network device 116 may comprise an identifier 118. As an example, one or more identifiers can be or relate to an Internet Protocol (IP) Address IPV4/IPV6 or a media access control address (MAC address) or the like. As a further example, the identifier 118 may be unique identifiers for facilitating communications on the physical network segment. Each of the network device 116 may comprise an identifier 118 that is distinct. As an example, the identifier 118 may be associated with a physical location of the network device 116.

The network device 116 may use a power consumption table 122 to determine a configuration of a set of parameters in order to manage the thermal efficiency of the network device 116. For example, a power consumption table 122 may be stored on the network device 116. The power consumption table 122 may comprise a plurality of configurations of the set of parameters that are associated with a plurality of power consumption levels associated with the network device 116. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas. As an example, a power consumption level of 23.5 W may be associated with a configuration of a frequency band and Wi-Fi standard of 2417b, a 20 MHz bandwidth, a MCS index of 1, and the use of a single antenna. The network device 116 may establish a first network connection between the network device 116 and a user device (e.g., one of the devices 102) according to a first configuration of the set of parameters associated with a first power consumption level associated with the network device. A temperature of the network device 116 may be determined based on the first network connection. Based on the temperature of the network device 116, the network device 116 may determine a second power consumption level associated with the network device 116. For example, if the temperature rises above a temperature threshold, the network device 116 may determine a second power consumption level that is lower than the first power consumption level. For example, if the first power consumption level was 23.5 W, the network device 116 may identify 23 W as the second consumption level. By using a lower power consumption level, the network device 116 may decrease the temperature of the network device 116 below the temperature threshold. In an example, the network device 116 may analyze each configuration of the plurality of configurations of the power consumption table 122 to determine a configuration that achieves the next power consumption level before switching to the second power consumption level. In an example, a fan of the network device 116 may also be activated based on the temperature rising above the temperature threshold. The network device 116 may determine a second configuration of the set of parameters based on the second power consumption level. For example, the network device 116 may identify a configuration of the set of parameters that achieves the second power consumption level. For example, if the network device 116 identified 23 W as the second power consumption level, the network device 116 may identify a configuration of the set of parameters that achieves 23 W based on the power consumption table 122. For example, the network device 116 may identify a configuration of a frequency band and Wi-Fi standard of 2417b, a 20 MHz bandwidth, a MCS index of 4, and the use of a single antenna, based on the power consumption table 122, that achieves the power consumption level of 23 W. In an example, the network device 116 may identify one or more parameters of the set of parameters to change/adjust while maintaining one or more of the parameters of the set of parameters in order to achieve the second power consumption level. As an example, all of parameters may be taken into account for reducing the temperature of the network device based on the network connection. The lower power consumption level may be selected that is associated with the least disruptive configuration of the set of parameters. For example, the spatial stream(s) may be reduced first, then the bandwidth, then the MCS rates, then the 802.11 mode, and then the channel to limit drastic drops in throughput performance. For example, the configuration of the set of parameters may be identified that minimizes the rapid reduction in throughput. As such, latency may be avoided by remaining in the same channel of the initial respective band of the initial network connection and the values of either of the NSS (e.g., antennas), the BW, the data rates, the 802.11 mode, the MCS, the RSSI, guard interval, and the SNR parameters may be adjusted (e.g., tuned down). For example, the network device 116 may maintain a same frequency band/Wi-Fi standard, bandwidth, and antenna configuration while changing/adjusting the MCS index in order to achieve the second power consumption level. The network device 116 may establish a second network connection between the network device 116 and the user device according to the second configuration of the set of parameters.

In an example, the network device 116 may gradually step down in power consumption levels in order to reduce the temperature of the network device 116 until the temperature falls below the temperature threshold. For example, the network device 116 may determine a second temperature of the network device 116 based on the second network connection. If the second temperature continues to increase, the network device 116 may determine a third power consumption level that is lower than the second power consumption level. For example, if the second power consumption level was 23 W, the network device 116 may identify 22 W as the third consumption level. By continuing to lower the power consumption level, the network device 116 may continue to attempt to decrease its temperature. The network device 116 may determine a third configuration of the set of parameters based on the third power consumption level. For example, the network device 116 may identify a configuration of the set of parameters that achieves the third power consumption level. For example, if the network device 116 identified 22 W as the third power consumption level, the network device 116 may identify a configuration of the set of parameters that achieves 22 W based on the power consumption table 122. For example, the network device 116 may identify a configuration of a frequency band and Wi-Fi standard of 2417b, a 20 MHz bandwidth, a MCS index of 5, and the use of a single antenna, based on the power consumption table 122, that achieves the power consumption level of 22 W. The network device 116 may establish a third network connection between the network device 116 and the user device according to the third configuration of the set of parameters. However, if the temperature of the network device 116 falls below a second temperature threshold based on the second network connection, the network device 116 may establish the third network connection between the network device 116 and the user device according to the first configuration of the set of parameters. The network device 116 may continue to repeat the process described above until the temperature of the network device 116 falls below the temperature threshold. In an example, the fan may also be deactivated once the temperature falls below the temperature threshold.

In an example, a user device (e.g., devices 102, network device 116, etc.) may lower its power consumption level when the user device is not in use, or is exchanging a low amount of data. A first user device, such as a printer or television, may establish a first network connection with a second user device, such as a smart phone or tablet computer according to a first configuration of the set of parameters associated with a first power consumption level associated with the first user device. For example, the first network connection may comprise an initial data throughput/usage associated with an amount of data being exchanged between the first user device and the second user device. In one example, printers are not used constantly, and thus, may be placed in sleep or low power mode when not in use. Thus, the printer's power consumption may be aggressively tuned to the lowest possible power consumption setting until it is utilized to accept the large data transfer when print spooling. In another example, a smart television may be placed in a low power mode when it is not streaming content. Based on the data throughput/usage associated with the first network connection, a second power consumption level associated with the first user device may be determined. For example, if the data throughput/usage rises above a data throughput/usage threshold, the first user device may identify the second power consumption level For example, the first user device may determine that a lowest power consumption level comprises 10 W. The first user device may determine a second configuration of the set of parameters based on the second power consumption level. For example, the first user device may identify a configuration of the set of parameters that achieves the second power consumption level. For example, if the first user device identified 10 W as the second power consumption level, the first user device may identify a configuration of the set of parameters that achieves 10 W based on the power consumption table 122. For example, the first user device may identify a configuration of a frequency band and Wi-Fi standard of 5955n, a 20 MHz bandwidth, a MCS index of 3, and the use of a single antenna, based on the power consumption table 122, that achieves the power consumption level of 10 W. The first user device may establish a second network connection between the first user device and the second user device according to the second configuration of the set of parameters. In an example, the first user device may determine that the data throughput/usage rises back up based on the second network connection. If the data throughput/usage rises above a second data throughput/usage threshold, the first device may establish a third network connection between the first user device and the second user device according to the first configuration of the set of parameters associated with the first power consumption level.

In an example, the network device 116 may establish a plurality of network connections with a plurality of user devices (e.g., devices 102). The network device 116 may manage its thermal efficiency by adjusting a power consumption level of each network connection based on the configurations of the set of parameters of the power consumption table 122. The network device 116 may establish a plurality of first network connections between the network device 116 and a plurality of user devices (e.g., devices 102). Each first network connection of the plurality of first network connections may be associated with a first configuration of the set of parameters associated with a first power consumption level. A temperature of the network device 116 may be determined based on the first plurality of first network connections. Based on the temperature of the network device 116, the network device 116 may determine a second power consumption level for each network connection. For example, if the temperature rises above a temperature threshold, the network device 116 may determine each second power consumption level that is lower than each first power consumption level. For example, if a first power consumption level of a first one of the first network connections is 23.5 , a first power consumption level of a second one of the first network connections is 23 W, and a first power consumption level of a third one of the first network connections is 18.5 W, the network device 116 may identify 22 W, 21 W, and 12.5 W as the second power consumption levels, respectively. By using lower power consumption levels for each first network connection, the network device 116 may decrease the temperature of the network device 116 below the temperature threshold. In an example, the network device 116 may analyze each configuration of the plurality of configurations of the power consumption table 122 for each of the first network connections to determine a configuration that achieves the next power consumption level for each of the first network connections before switching to the second power consumption level for each of the first network connections. The network device 116 may determine a plurality of second configurations of the set of parameters based on each second power consumption level. For example, the network device 116 may identify configurations of the set of parameters that achieve each second power consumption level. For example, if the second power consumption levels comprised 22 W, 21 W, and 12.5 W, the network device 116 may identify configurations of the set of parameters that achieve 22 W, 21 W, and 12.5 W based on the power consumption table 122. For example, the network device 116 may identify a configuration of a frequency band and Wi-Fi standard of 2417g, a 20 MHz bandwidth, a MCS index of 0, and the use of a four antennas, based on the power consumption table 122, that achieves the power consumption level of 22 W. In addition, the network device 116 may identify a configuration of a frequency band and Wi-Fi standard of 5230n, a 40 MHz bandwidth, a MCS index of 0, and the use of a four antennas, based on the power consumption table 122, that achieves the power consumption level of 21 W. Lastly, the network device 116 may identify a configuration of a frequency band and Wi-Fi standard of 6125n, a 40 MHz bandwidth, a MCS index of 6, and the use of a four antennas, based on the power consumption table 122, that achieves the power consumption level of 12.5 W. The network device 116 may establish a plurality of second network connections between the network device 116 and the plurality of user devices, wherein each second network connection of the plurality of second network connections may be associated with a second configuration of the set of parameters associated with the corresponding second power consumption level of the plurality of second power consumption levels. For example, the network device 116 may have initially established a first network connection with a first user device via a 2412 GHz channel 1 with a bandwidth of 10 MHz, a first network connection with a second user device via a 5180 GHz channel 36 with a bandwidth of 80 MHz, and a first network connection with a third user device via a 6825 GHz channel 175 with a bandwidth of 40 MHz. As a result, the network device 116 may identify the configurations of the set of parameters that include channels closest to the initial channels used to establish the initial network connections in order to avoid adjacent channel interference. For example, the network device 116 may established a second network connection with the first user device via a 2417 GHz channel 2 with a bandwidth of 20 MHz, a second network connection with the second user device via a 5230 GHz channel 46 with a bandwidth of 40 MHz, and a second network connection with the third user device via a 6125 GHz channel 35 with a bandwidth of 40 MHz. The parameters may be adjusted with minimal impact to performance/throughput in order to adjust the temperature of the network device 116. In an example, the network device 116 may gradually step down each power consumption level of each network connection in order to reduce the temperature of the network device 116 until the temperature falls below the temperature threshold.

The computing device 104 may comprise a server, or a centralized device, for communicating with the network device 116, or the devices 102 via the network device 116. In an example, the computing device 104 may communicate with the devices 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the devices 102 to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The computing device 104 may be configured to manage the communication between the devices 102 and/or the network device 116 and a storage system 114 for sending and receiving data therebetween. As an example, the storage system 114 may store a plurality of files, user identifiers or records, or other information. As a further example, the devices 102 may request and/or retrieve one or more files from the storage system 114. The storage system 114 may store information relating to the devices 102 such as the address elements 110 and/or the service elements 112. As an example, the computing device 104 may obtain the device identifiers 108 from the devices 102 and retrieve information from the storage system 114 such as the address elements 110 and/or the service elements 112. As a further example, the computing device 104 may obtain the address elements 110 from the devices 102 and may retrieve the service elements 112 from the storage system 114, or vice versa. As an example, the computing device 104 may obtain the identifier 118 from the network device 116 and retrieve information associated with the network device 116 from the storage system 114. Any information can be stored in and retrieved from the storage system 114. The storage system 114 can be disposed remotely from the computing device 104 and accessed via direct or indirect connection. The computing device 104 may store one or more power consumption tables 122 in the storage system 114. As an example, the network device 116 may retrieve the power consumption table 122 from the computing device 104. The storage system 114 can be integrated with the computing device 104 or some other device or system.

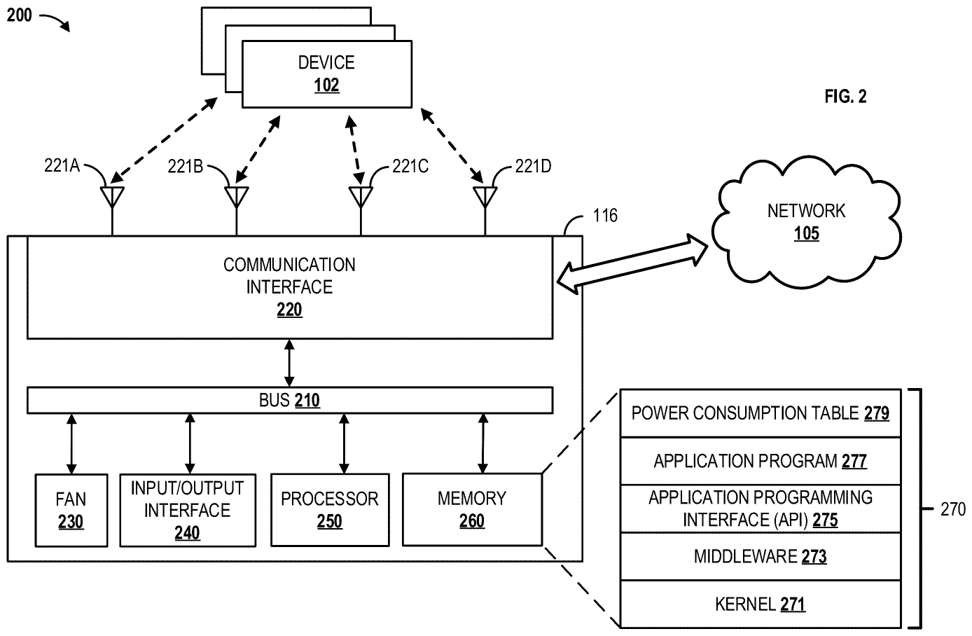

FIG. 2 shows an example system 200 of a network device (e.g., network device 116). The system 200 may include one or more devices 102 and a network device 116. The network device 116 may be configured to control a temperature of the network device 116 based on determining a configuration of a set of parameters according to a power consumption table (e.g., power consumption table 279) in order to achieve a power consumption level. The network device 116 may be in communication with the one or more devices 102 via one or more antennas (e.g., antennas 221A, 221B, 221C, 221D) for facilitating the connection of the devices 102 to a network (e.g., network 105). The network device 116 may include a bus 210, a communication interface 220, one or more fans 230, an input/output interface 240, one or more processors 250, and a memory 260. In certain examples, the network device 116 may omit at least one of the aforementioned elements or may additionally include other elements. The network device 116 may be configured as one or more of a set top box, a wireless access point (WAP), a gateway device, or a combination thereof.

The bus 210 may comprise a circuit for connecting the bus 210, the communication interface 220, the one or more fans 230, the input/output interface 240, the one or more processors 250, and the memory 260 to each other and for delivering communication (e.g., a control message and/or data) between the bus 210, the communication interface 220, the one or more fans 230, the input/output interface 240, the one or more processors 250, and the memory 260.

The communication interface 220 may comprise one or more transceivers for facilitating communication between the one or more devices 102 and the network 105. For example, the network 105 may include at least one of a telecommunications network, a computer network (e.g., LAN or WAN), the Internet, and/or a telephone network. The communication interface 220 may be configured to communicate with the one or more devices 102 via one or more antennas 221A, 221B, 221C, 221D. In an example, the communication interface 220 may be configured to access the network 105 via a wireless communication interface such as a cellular communication protocol. The cellular communication protocol may comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface may be configured to use a near-distance communication. The near-distance communication interface may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document.

The one or more fans 230 may be activated in order to cool down one or more components of the network device 116 based on a temperature of the network device 116 rising above a temperature threshold. In an example, the one or more fans 230 may be deactivated if the temperature stabilizes or once the temperature falls below the temperature threshold.

The input/output interface 240 may include an interface for delivering an instruction or data input from a user or from one or more of the devices 102 to the different elements of the network device 116. The input/output interface 240 may further include an interface for outputting one or more user interfaces to the user. For example, the input/output interface 240 may comprise a display, such as a touch screen display, and/or one or more physical input interfaces (e.g., keyboard, mouse, etc.) configured to receive user inputs. The input/output interface 240 may output an instruction or data received from one or more elements of the network device 116 to one or more of the devices 102.

The one or more processors 240 may include one or more of a Central Processing Unit (CPU), an Application Processor (AP), or a Communication Processor (CP). The one or more processors 240 may control, for example, at least one of the bus 210, the communication interface 220, the one or more fans 230, the input/output interface 240, the one or more processors 250, and the memory 260 of the network device 116 and/or may execute an arithmetic operation or data processing for communication.

The memory 260 may include a volatile and/or non-volatile memory. The memory 260 may store, for example, a command or data related to at least one different constitutional element of the network device 116. In an example, the memory 260 may store a software and/or a program 270. The program 270 may include, for example, a kernel 271, a middleware 273, an Application Programming Interface (API) 275, an application program (or an “application”) 277, and/or a power consumption table 279, or the like, configured for controlling one or more functions of the network device 116. At least one part of the kernel 271, middleware 273, or API 275 may be referred to as an Operating System (OS). The memory 270 may include a computer-readable recording medium having a program recorded therein to perform the method according to various embodiments by the processor 250.

The kernel 271 may control or manage, for example, system resources (e.g., the bus 210, the communication interface 220, the one or more fans 230, the input/output interface 240, the one or more processors 250, the memory 260, etc.) used to execute an operation or function implemented in other programs (e.g., the middleware 273, the API 275, or the application program 277). Further, the kernel 271 may provide an interface capable of controlling or managing the system resources by accessing individual constitutional elements of the network device 116 in the middleware 273, the API 275, the application program 277, or the power consumption table 279.

The middleware 273 may perform, for example, a mediation role so that the API 275 or the application program 277 can communicate with the kernel 271 to exchange data. Further, the middleware 273 may handle one or more task requests received from the application program 277 according to a priority. For example, the middleware 273 may assign a priority of using the system resources (e.g., the bus 210, the communication interface 220, the one or more fans 230, the input/output interface 240, the one or more processors 250, or the memory 260) of the network device 116 to the application program 277. For example, the middleware 153 may process the one or more task requests according to the priority assigned to the application program 277, and thus, may perform scheduling or load balancing on the one or more task requests.

The API 275 may include at least one interface or function (e.g., instruction), for example, for file control, window control, video processing, or character control, as an interface capable of controlling a function provided by the application 277 in the kernel 271 or the middleware 273.

The application program 277 may include logic (e.g., hardware, software, firmware, etc.) that may be implemented the network device 116 to manage the temperature of the network device 116. For example, the network device 116 may use a power consumption table 279 to determine a configuration of a set of parameters in order to manage the thermal efficiency of the network device 116. For example, the power consumption table 279 may be stored in the memory 260 of the network device 116. The power consumption table 279 may comprise a plurality of configurations of the set of parameters that are associated with a plurality of power consumption levels associated with the network device 116. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas (e.g., one or more of the antennas 221A, 221B, 221C, 221D to activate/deactivate). The network device 116 may establish a first network connection between the network device 116 and one or more of the devices 102 (e.g., via one or more of the antennas 221A, 221B, 221C, 221D) according to a first configuration of the set of parameters associated with a first power consumption level associated with the network device. A temperature of the network device 116 may be determined based on the first network connection. Based on the temperature of the network device 116, the application program 277 may cause the network device 116 to determine a second power consumption level associated with the network device 116. For example, if the temperature rises above a temperature threshold, the application program 277 may cause the network device 116 to determine a second power consumption level that is lower than the first power consumption level. By using a lower power consumption level, the network device 116 may decrease the temperature of the network device 116 below the temperature threshold. In an example, the network device 116 may analyze each configuration of the plurality of configurations of the power consumption table 279 to determine a configuration that achieves the next power consumption level before switching to the second power consumption level. In an example, the application program 277 may also cause the network device 116 to activate one or more of the fans 230 based on the temperature rising above the temperature threshold. The network device 116 may access the power consumption table 279 to determine a second configuration of the set of parameters based on the second power consumption level. For example, the network device 116 may identify a configuration of the set of parameters that achieves the second power consumption level. In an example, the network device 116 may identify one or more parameters of the set of parameters to change/adjust while maintaining one or more of the parameters of the set of parameters in order to achieve the second power consumption level. As an example, all of the parameters may be taken into account for reducing the temperature of the network device 116 based on the network connection. The lower power consumption level may be selected that is associated with the least disruptive configuration of the set of parameters. For example, the spatial stream(s) (e.g., one or more of the antennas 221A, 221B, 221C, 221D) may be reduced first, then the bandwidth, then the MCS rates, then the 802.11 mode, and then the channel to limit drastic drops in throughput performance. For example, the configuration of the set of parameters may be identified that minimizes the rapid reduction in throughput. As such, latency may be avoided by remaining in the same channel of the initial respective band of the initial network connection and the values of either of the NSS (e.g., one or more of the antennas 221A, 221B, 221C, 221D), the BW, the data rates, the 802.11 mode, the MCS, the RSSI, guard interval, and the SNR parameters may be adjusted (e.g., tuned down). For example, the network device 116 may maintain a same frequency band/Wi-Fi standard, bandwidth, and antenna configuration (e.g., one or more of the antennas 221A, 221B, 221C, 221D) while changing/adjusting the MCS index in order to achieve the second power consumption level. The application program 277 may cause the network device 116 to establish a second network connection between the network device 116 and the device 102 according to the second configuration of the set of parameters. In an example, the application program 277 may cause the network device 116 to gradually step down in power consumption levels in order to reduce the temperature of the network device 116 until the temperature falls below the temperature threshold.

In an example, the network device 116 may establish a plurality of network connections with a plurality of the devices 102 via one or more of the antennas 221A, 221B, 221C, 221D. The network device 116 may manage its thermal efficiency by adjusting a power consumption level of each network connection based on the configurations of the set of parameters of the power consumption table 279. The network device 116 may establish a plurality of first network connections between the network device 116 and a plurality of the devices 102 via one or more of the antennas 221A, 221B, 221C, 221D. Each first network connection of the plurality of first network connections may be associated with a first configuration of the set of parameters associated with a first power consumption level. A temperature of the network device 116 may be determined based on the first plurality of first network connections. Based on the temperature of the network device 116, the application program 277 may cause the network device 116 to determine a second power consumption level for each network connection. For example, if the temperature rises above a temperature threshold, the network device 116 may determine each second power consumption level that is lower than each first power consumption level. By using lower power consumption levels for each first network connection, the network device 116 may decrease the temperature of the network device 116 below the temperature threshold. In an example, the network device 116 may analyze each configuration of the plurality of configurations of the power consumption table 279 for each of the first network connections to determine a configuration that achieves the next power consumption level for each of the first network connections before switching to the second power consumption level for each of the first network connections. The network device 116 may determine a plurality of second configurations of the set of parameters based on each second power consumption level. For example, the network device 116 may identify configurations of the set of parameters that achieve each second power consumption level. The network device 116 may establish a plurality of second network connections between the network device 116 and the plurality of devices 102 via one or more of the antennas 221A, 221B, 221C, 221D, wherein each second network connection of the plurality of second network connections may be associated with a second configuration of the set of parameters associated with the corresponding second power consumption level of the plurality of second power consumption levels. As an example, the network device 116 may identify the configurations of the set of parameters that include channels closest to the initial channels used to establish the initial network connections in order to avoid adjacent channel interference. As such, the parameters may be adjusted with minimal impact to performance/throughput in order to adjust the temperature of the network device 116. In an example, the network device 116 may gradually step down each power consumption level of each network connection in order to reduce the temperature of the network device 116 until the temperature falls below the temperature threshold.

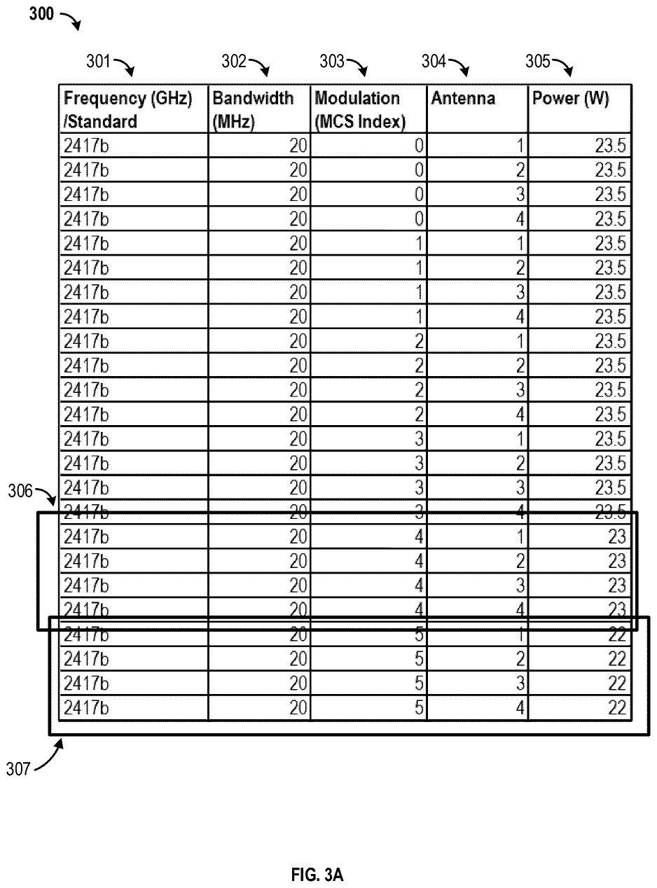

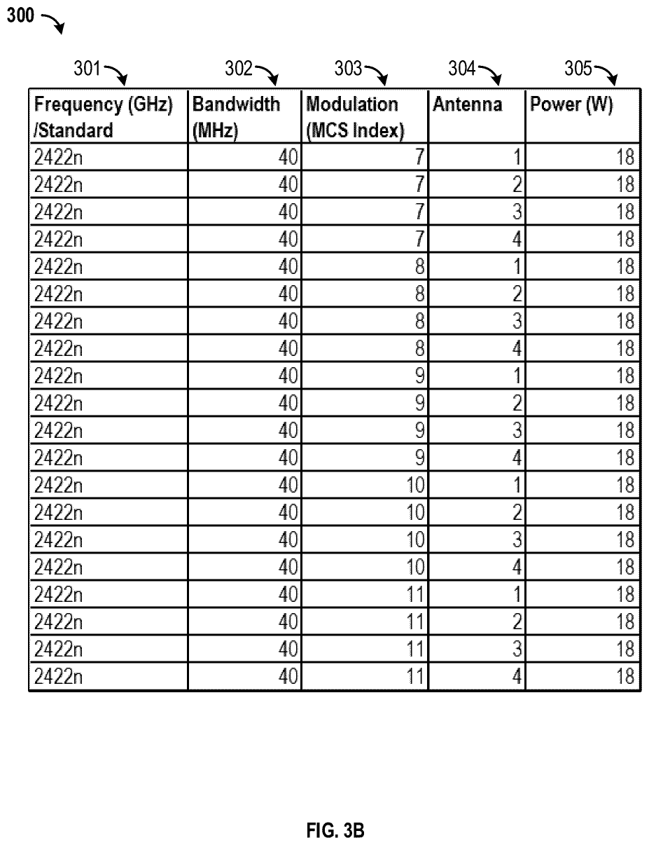

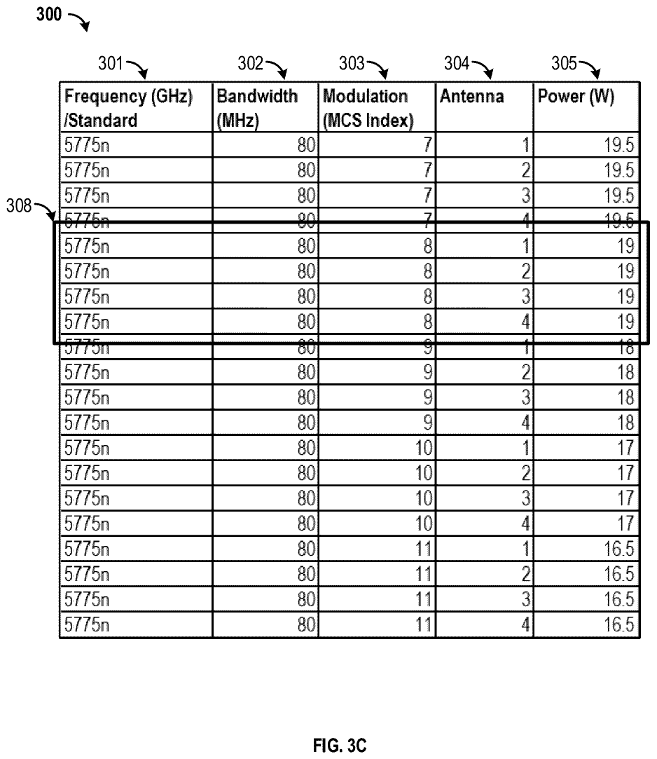

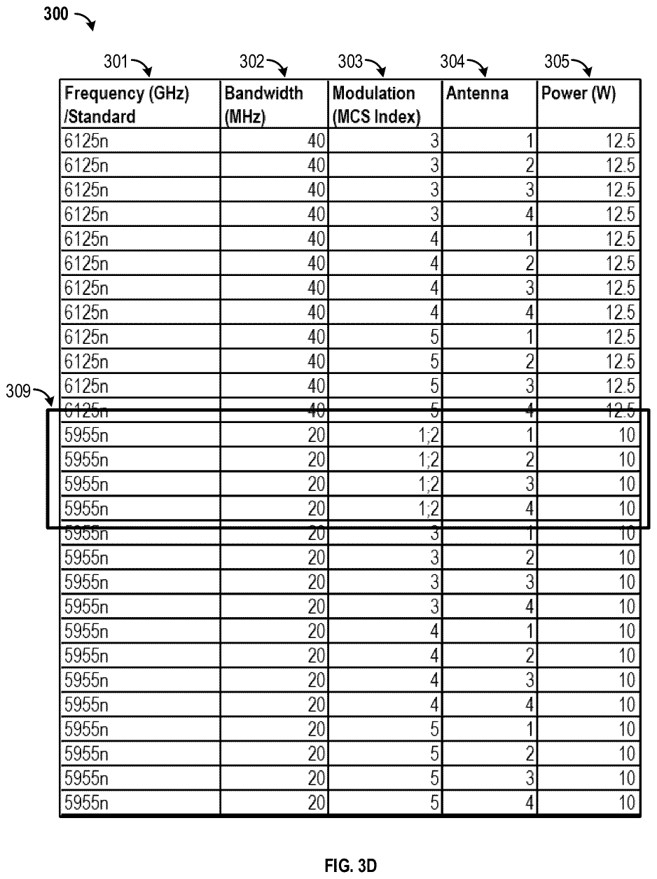

FIGS. 3A-3D show an example power consumption table 300 (e.g., power consumption table 122). The power consumption table 300 may comprise a plurality of configurations of the set of parameters that are associated with a plurality of power consumption levels 305 associated with a network device (e.g., network device 116). Each configuration of the plurality of configurations may be used to determine each power consumption level 305 of the plurality of power consumption levels 305. The set of parameters may comprise one or more of a frequency band/Wi-Fi standard 301, a bandwidth 302, a modulation coding scheme (MCS) index 303, or a number of antennas 304. For example, the network device may use a configuration of the set of parameters to achieve a power consumption level 305. For example, as shown in FIG. 3A, a configuration of a frequency band and Wi-Fi standard of 2417b, a 20 MHz bandwidth, a MCS index of 1, and a single antenna may achieve a power consumption level of 23.5 W. The network device may mange its thermal efficiency by lowering its power consumption level 305. For example, a temperature of the network device may rise above a temperature while the network device maintains a network connection with a user device (e.g., one of the devices 102). The network device may lower its power consumption level 305 by identifying a configuration of the set of parameters associated with a lower power consumption level 305. The network device may retrieve (e.g., from memory) the power consumption table 300 to identify a configuration of the set of parameters associated with the lower power consumption level 305. As an example, all of the parameters may be taken into account for reducing the temperature of the network device based on the network connection (or each network connection). The lower power consumption level 305 may be selected that is associated with the least disruptive configuration of the set of parameters. In an example, the spatial stream(s) may be adjusted (e.g., increased or reduced) first, then the bandwidth, then the MCS rates, then the 802.11 mode, and then the channel to limit drastic drops in throughput performance. As an example, any one of the parameters may be increased or reduced in order to lower the temperature of the network device. For example, the network device may identify a configuration 306 of the set of parameters associated with a power consumption level of 23 W. The network device may identify the configuration 306 of a frequency band and Wi-Fi standard of 2417b, a 20 MHz bandwidth, a MCS index of 4, and the use of a single antenna in order to achieve the power consumption level 305 of 23 W. In an example, the network device may analyze each configuration of the plurality of configurations of the power consumption table 300 to determine a configuration that achieves the next power consumption level 305 before switching to the next lower power consumption level 305.

The network device may gradually lower its power consumption level 305 in order to gradually reduce its temperature below the temperature threshold. For example, the temperature may be determined based on a time interval (e.g., every 5 seconds, 10 seconds, 30 seconds, etc.). For example, the power consumption level 305 of 23 W may not result in the temperature falling below the temperature threshold. Thus, the network device may determine a next power consumption level 305 of 22 W. The network device may use the power consumption table 300 to identify a configuration 307 of a frequency band and Wi-Fi standard of 2417b, a 20 MHz bandwidth, a MCS index of 5, and the use of a single antenna in order to achieve the power consumption level 305 of 22 W. The network device may continue to lower the power consumption level 305 until the temperature of the network device falls below the temperature threshold. As an example, the network device may determine a next power consumption level 305 of 18 W. As shown in FIG. 3B, the network device may use the power consumption table 300 to identify a configuration of a frequency band and Wi-Fi standard of 2422b, a 40 MHz bandwidth, a MCS index of 7, and the use of a single antenna in order to achieve the power consumption level 305 of 18 W. In an example, the temperature of the network device may fall below a second temperature threshold based on a network connection established with the user device according to the power consumption level 305 of 18 W. As such, the network device may determine a power consumption level 305 of 19 W that is higher than the previous consumption level 305 of 18 W. As shown in FIG. 3C, the network device may use the power consumption table 300 to identify a configuration 308 of a frequency band and Wi-Fi standard of 5775n, an 80 MHz bandwidth, a MCS index of 8, and the use of a single antenna in order to achieve the power consumption level 305 of 19 W. In an example, the temperature of the network device may start to rise again based on a network connection established with the user device (e.g., based on additional data throughput/usage) according to the power consumption level 305 of 19 W. As such, the network device may gradually continue to lower the power consumption level 305 until reaching 10 W, for example. As shown in FIG. 3D, the network device may use the power consumption table 300 to identify a configuration 309 of a frequency band and Wi-Fi standard of 5955n, an 20 MHz bandwidth, a MCS index of 1 or 2, and the use of a single antenna in order to achieve the power consumption level 305 of 10 W.

As an example, the network device may evaluate the network connection (or each network connection) by calculating Tput=RSSI+SNR+Data Rates+Channel+802.11 Mode +MCS+BW+NSS (antennas). Tput may be described as the throughput yielded from amassing all of the parameters. Tput may gradually step-down by tuning any of the parameters to minimize rapid, drastic reduction in throughput. In an example, latency may be avoided by remaining in the same channel of the initial respective band of the initial network connection and begin adjusting (e.g., tuning down) the values of either of the NSS (antenna), the BW, the data rates, the 802.11 mode, the MCS, the RSSI, and/or the SNR parameters. For example, if RSSI >=−65 dBm and SNR >=−90 dBM, then MCS 9 may be increased (e.g., stepping power down, since the lower MCS results in components of the network device working harder to maintain data rates), while maintaining the values of the other parameters. If the network device needs to be cooled down further (e.g., to lower the temperature below the temperature threshold), more aggressive changes/adjustments to the values of the other parameters may be implemented. Once the temperature of the network device stabilizes, then the network device may be restored to the original configuration of the set of parameters.

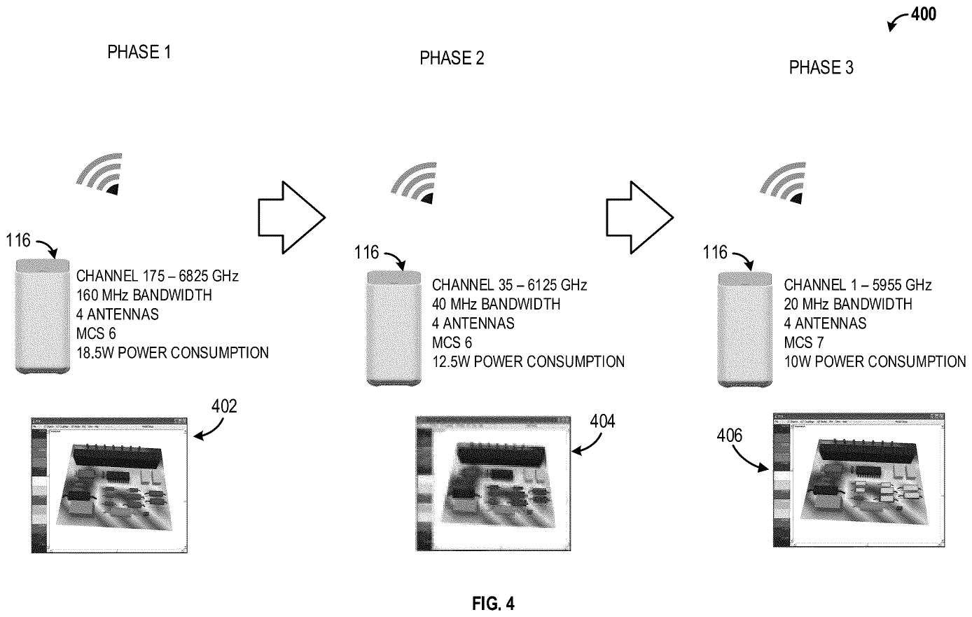

FIG. 4 shows an example scenario 400 of a network device (e.g., network device 116) configured to lower its power consumption level based on a power consumption table to reduce its temperature. As shown in FIG. 4, at Phase 1, the network device 116 may initially establish a network connection with a user device (e.g., one of the devices 102) according to an initial configuration of the set of parameters associated with a first power consumption level. For example, the network device 116 may establish the network connection according to a configuration of a frequency band and Wi-Fi standard of 6825b via channel 175, a 160 MHz bandwidth, a MCS index of 6, and the use of four antennas associated with a power consumption level of 18.5 W. As data throughput increases due to high data usage, heat may build up rapidly towards the temperature threshold. For example, certain components 402 of the network device 116 may rapidly heat up based on the initial network connection. Based on the temperature rising above the temperature threshold, the network device 116 may retrieve the power consumption table, at Phase 2, to reduce the power consumption level in order to alleviate the heat/temperature build-up of the network device 116. For example, the network device 116 may reduce the power consumption level to 12.5 W. Thus, the network device 116 may identify a configuration of the set of parameters, based on the power consumption table, that achieves the power consumption level of 12.5 W. For example, the network device 116 may establish the network connection according to a configuration of a frequency band and Wi-Fi standard of 6125b via channel 35, a 40 MHz bandwidth, a MCS index of 6, and the use of four antennas associated with the power consumption level of 12.5 W. As a result, the temperature of the network device 116 may begin to fall. Thus, certain components 404 may begin to cool down. In an example, a fan of the network device 116 may be activated to assist in alleviating the heat/temperature build up. At Phase 3, the network device 116 may continue to lower the power consumption to reduce its temperature below the temperature threshold. The network device 116 may identify a configuration of the set of parameters, based on the power consumption table, that achieves a power consumption level of 10 W. For example, the network device 116 may establish the network connection according to a configuration of a frequency band and Wi-Fi standard of 5955n via channel 1, a 20 MHz bandwidth, a MCS index of 1, and the use of four antennas associated with the power consumption level of 10 W. Thus, certain components 406 may cool down and the temperature of the network device 116 may fall below the temperature threshold. In an example, the network device 116 may analyze each configuration of the plurality of configurations of the power consumption table to determine a configuration that achieves the next power consumption level before switching to the next lower power consumption level. In an example, the fan may also be deactivated once the temperature falls below the temperature.

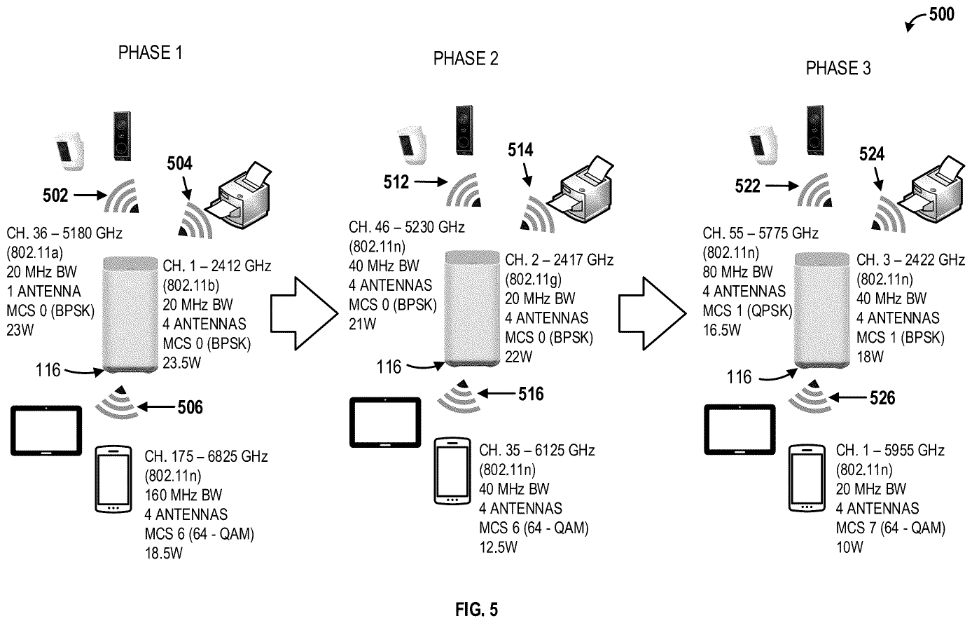

FIG. 5 shows an example scenario 500 of a network device (e.g., network device 116) configured to lower its power consumption level based on a power consumption table to reduce its temperature. As shown in FIG. 5, at Phase 1, the network device 116 may initially establish three network connections with several user devices (e.g., devices 102) according to three configurations of the set of parameters. The network device 116 may establish a first network connection 502 according to a configuration of a frequency band and Wi-Fi standard of 5180a via channel 36, a 20 MHz bandwidth, a MCS index of 0 (binary phase shift keying (BPSK)), and the use of a single antenna associated with a power consumption level of 23 W. The network device 116 may establish a second network connection 504 according to a configuration of a frequency band and Wi-Fi standard of 2412b via channel 1, a 20 MHz bandwidth, a MCS index of 0 (BPSK), and the use of four antennas associated with a power consumption level of 23.5 W. The network device 116 may establish a third network connection 506 according to a configuration of a frequency band and Wi-Fi standard of 6825n via channel 175, a 160 MHz bandwidth, a MCS index of 6 (64—quadrature amplitude (QAM)), and the use of four antennas associated with a power consumption level of 12.5 W. As data throughput of one or more of the network connections increases due to high data usage, heat may build up rapidly towards the temperature threshold. Based on the temperature rising above the temperature threshold, the network device 116 may retrieve the power consumption table, at Phase 2, to reduce the power consumption levels of each network connection in order to alleviate the heat/temperature build-up of the network device 116. For example, the network device 116 may reduce the power consumption levels to 21 W, 22 W, and 12.5 W, respectively, of each network connection. Thus, the network device 116 may identify configurations of the set of parameters, based on the power consumption table, that achieve the power consumption levels of 21 W, 22 W, and 12.5 W. The network device 116 may establish a first network connection 412 according to a configuration of a frequency band and Wi-Fi standard of 5230n via channel 46, a 40 MHz bandwidth, a MCS index of 0 (BPSK), and the use of four antennas associated with the power consumption level of 21 W. The network device 116 may establish a second network connection 514 according to a configuration of a frequency band and Wi-Fi standard of 2417 g via channel 2, a 20 MHz bandwidth, a MCS index of 0 (BPSK), and the use of four antennas associated with a power consumption level of 22 W. The network device 116 may establish a third network connection 516 according to a configuration of a frequency band and Wi-Fi standard of 6125n via channel 35, a 40 MHz bandwidth, a MCS index of 6 (64—QAM), and the use of four antennas associated with a power consumption level of 12.5 W. As a result, the temperature of the network device 116 may begin to fall. In an example, a fan of the network device 116 may be activated to assist in alleviating the heat/temperature build up. At Phase 3, the network device 116 may continue to lower the power consumption to reduce its temperature below the temperature threshold. The network device 116 may identify configurations of the set of parameters, based on the power consumption table, that achieve power consumption levels of 16.5 W, 18 W, and 10 W, respectively, for each network connection. The network device 116 may establish a first network connection 522 according to a configuration of a frequency band and Wi-Fi standard of 5775n via channel 55, a 80 MHz bandwidth, a MCS index of 1 (quadrature phase shift keying (QPSK)), and the use of four antennas associated with the power consumption level of 16.5 W. The network device 116 may establish a second network connection 524 according to a configuration of a frequency band and Wi-Fi standard of 2422n via channel 3, a 40 MHz bandwidth, a MCS index of 1 (BPSK), and the use of four antennas associated with a power consumption level of 18 W. The network device 116 may establish a third network connection 526 according to a configuration of a frequency band and Wi-Fi standard of 5955n via channel 1, a 20 MHz bandwidth, a MCS index of 7 (64—QAM), and the use of four antennas associated with a power consumption level of 10 W. Thus, the temperature of the network device 116 may fall below the temperature threshold based on the new configurations of the set of parameters for each network connection. As an example, the network device 116 may identify configurations of the set of parameters that include channels closest to the initial channels used to establish the initial network connections in order to avoid adjacent channel interference. In an example, the network device 116 may analyze each configuration of the plurality of configurations of the power consumption table for each of the first network connections to determine a configuration that achieves the next power consumption level for each of the first network connections before switching to the second power consumption level for each of the first network connections. In an example, the fan may also be deactivated once the temperature falls below the temperature.

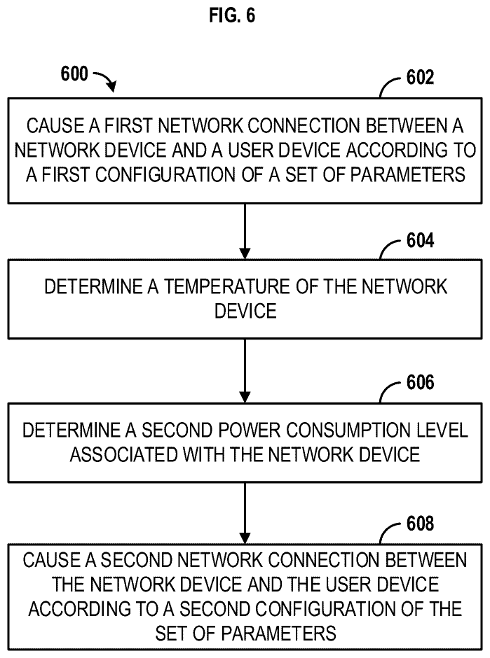

FIG. 6 shows a flowchart of an example method 600 for managing thermal efficiency of a network device. Method 600 may be implemented, for example, by a network device (e.g., network device 116, etc.). At step 602, a first network connection may be established/caused between a network device and a user device according to a first configuration of a set of parameters associated with a first power consumption level associated with the network device. For example, a network device (e.g., network device 116, etc.) may establish/cause the first network connection between the network device and the user device according to the first configuration of the set of parameters associated with the first power consumption level associated with the network device. The first configuration of the set of parameters may be based on a power consumption table. For example, a power consumption table may be stored on the network device. The power consumption table may comprise a plurality of configurations of the set of parameters that are associated with a plurality of power consumption levels associated with the network device. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas.

At step 604, a temperature of the network device may be determined based on the first network connection. For example, the network device (e.g., network device 116, etc.) may determine the temperature based on the first network connection.

At step 606, based on the temperature of the network device, a second power consumption level associated with the network device may be determined. For example, the network device (e.g., network device 116, etc.) may determine the power consumption level associated with the network device based on the temperature of the network device. As an example, the second power consumption level associated with the network device may be determined based on the temperature rising above a threshold. For example, if the temperature rises above a temperature threshold, the network device may determine a second power consumption level that is lower than the first power consumption level. For example, if the first power consumption level was 23.5 W, the network device may identify 23 W as the second consumption level. By using a lower power consumption level, the network device may decrease the temperature of the network device below the temperature threshold. In an example, each configuration of the plurality of configurations of the power consumption table may be analyzed to determine a configuration that achieves the next power consumption level before switching to the second power consumption level. In an example, a fan of the network device may also be activated based on the temperature rising above the threshold.

At step 608, a second network connection between the network device and the user device may be established/caused according to a second configuration of the set of parameters based on the second power consumption level. For example, the network device (e.g., network device 116, etc.) may establish/cause the second network connection between the network device and the user device according to the second configuration of the set of parameters based on the second power consumption level. For example, the network device may identify a configuration of the set of parameters that achieves the second power consumption level. For example, if the network device identified 23 W as the second power consumption level, the network device may identify a configuration of the set of parameters that achieves 23 W based on the power consumption table. In an example, the second configuration of the set of parameters may comprise one or more of a same frequency band, a same modulation, or a same number of antennas as the first configuration of the set of parameters. For example, the network device may identify one or more parameters of the set of parameters to change/adjust while maintaining one or more of the parameters of the set of parameters in order to achieve the second power consumption level. For example, the network device may maintain a same frequency band/Wi-Fi standard, bandwidth, and antenna configuration while changing/adjusting the MCS index in order to achieve the second power consumption level.

In an example, a second temperature of the network device may be determined based on the second network connection. In one example, a third power consumption level may be determined based on the second temperature continuing to increase. A third network connection between the network device and the user device may be established/caused according to a third configuration of the set of parameters based on the third power consumption level. In another example, a third network connection between the network device and the user device may be established/caused according to the first configuration of the set of parameters or the second configuration of the set of parameters based on the second temperature of the network device falling below a second threshold.

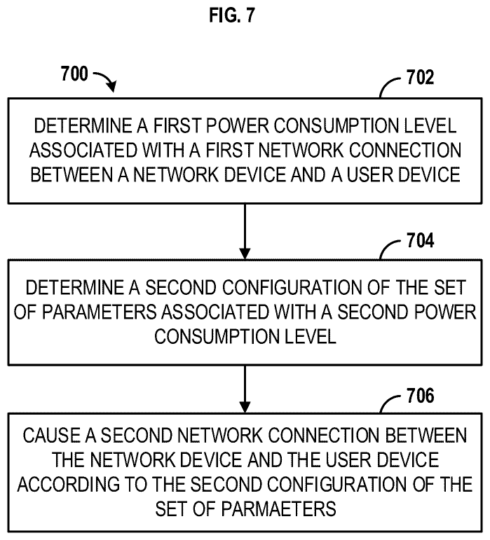

FIG. 7 shows a flowchart of an example method 700 for managing thermal efficiency of a network device. Method 700 may be implemented, for example, by a network device (e.g., network device 116, etc.). At step 702, a first power consumption level associated with a first network connection between a network device and a user device may be determined based on a temperature of a network device. For example, a network device (e.g., network device 116, etc.) may determine the first power consumption level associated with the first network connection between the network device and the user device based on the temperature of the network device. For example, if the temperature rises above a temperature threshold, the network device may determine the first power consumption level that is lower than an initial power consumption level. For example, if the initial power consumption level was 23.5 W, the network device may identify 23 W as the first consumption level. By using a lower power consumption level, the network device may decrease the temperature of the network device below the temperature threshold. In an example, a fan of the network device may also be activated based on the temperature rising above the threshold.

At step 704, based on a first configuration of a set of parameters associated with the first power consumption level, a second configuration of the set of parameters associated with a second power consumption level may be determined. For example, the network device (e.g., network device 116, etc.) may determine the second configuration of the set of parameters associated with the second power consumption level based on the first configuration of the set of parameters associated with the first power consumption level. The second power consumption level may be lower than the first power consumption level. For example, the network device may identify a power consumption level (e.g., the second power consumption level) that is lower than the first power consumption level. One or more of the first configuration of the set of parameters or the second configuration of the set of parameters may be based on a power consumption table. For example, a power consumption table may be stored on the network device. The power consumption table may comprise a plurality of configurations of the set of parameters that are associated with a plurality of power consumption levels associated with the network device. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas. The network device may identify a configuration of the set of parameters that achieves the second power consumption level. For example, the network device may analyze each configuration of the plurality of configurations of the power consumption table to determine a configuration that achieves the second power consumption level before switching to the second power consumption level. For example, if the network device identified 23 W as the second power consumption level, the network device may identify a configuration of the set of parameters that achieves 23 W based on the power consumption table. As an example, the network device may identify a second configuration of the set of parameters that includes a channel that is closest to the initial channel used to establish the initial network connection in order to avoid adjacent channel interference. For example, the second configuration of the set of parameters may comprise one or more of a same frequency band, a same modulation, or a same number of antennas as the first configuration of the set of parameters. For example, the network device may identify one or more parameters of the set of parameters (e.g., bandwidth or number of antennas) to change/adjust while maintaining one or more of the parameters of the set of parameters (e.g., frequency band, Wi-Fi standard, MCS index, or guard interval) in order to achieve the second power consumption level.

At step 706, a second network connection between the network device and the user device may be established/caused according to the second configuration of the set of parameters. For example, network device (e.g., network device 116, etc.) may establish/cause the second network connection between the network device and the user device according to the second configuration of the set of parameters.

In an example, a second temperature of the network device may be determined based on the second network connection. In one example, a third power consumption level may be determined based on the second temperature continuing to increase. A third network connection between the network device and the user device may be established/caused according to a third configuration of the set of parameters based on the third power consumption level. In another example, a third network connection between the network device and the user device may be established/caused according to the first configuration of the set of parameters or the second configuration of the set of parameters based on the second temperature of the network device falling below a second threshold.

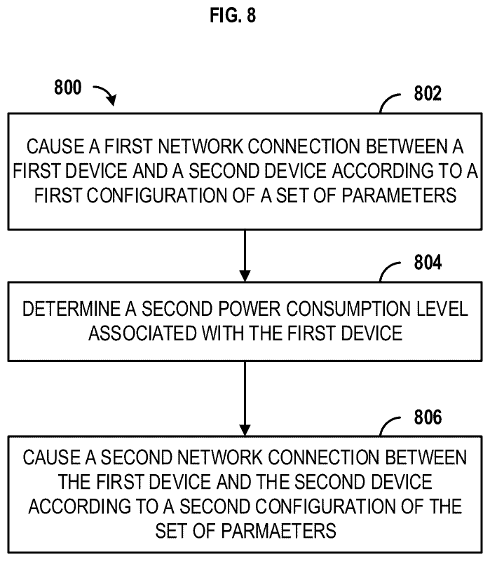

FIG. 8 shows a flowchart of an example method 800 for managing thermal efficiency of a user device. Method 800 may be implemented, for example, by a device (e.g., devices 102, network device 116, etc.). At step 802, a first network connection between a first device and a second device according to a first configuration of a set of parameters associated with a first power consumption level associated with the first device may be established/caused. For example, a first device (e.g., devices 102, network device 116, etc.) may establish/cause the first network connection between the first device and the second device according to the first configuration of the set of parameters associated with the first power consumption level associated with the first device. The first configuration of the set of parameters may be based on a power consumption table. For example, a power consumption table may be stored on the first device. The power consumption table may comprise a plurality of configurations of the set of parameters that are associated with a plurality of power consumption levels associated with the first device. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas.

At step 804, based on a data throughput associated with the first network connection, a second power consumption level associated with the first device may be determined. For example, the first device (e.g., devices 102, network device 116, etc.) may determine the second power consumption level associated with the first device based on the data throughput associated with the first network connection. For example, devices such as printers are not used constantly, and thus, may need to be placed in a lower power mode when not in use. Therefore, the printer's power consumption may be aggressively tuned to the lowest possible power consumption setting until it is utilized to accept a large data transfer when print spooling. In one example, the first device may determine a second power consumption level that is lower than the first power consumption level based on the data throughput falling below a threshold (e.g., a low power mode). In another example, the first device may determine a second power consumption level that is greater than the first power consumption level based on the data throughput rising above a threshold (e.g., an active power mode).

At step 806, a second network connection between the first device and the second device may be established/caused according to a second configuration of the set of parameters based on the second power consumption level. For example, the first device (e.g., devices 102, network device 116, etc.) may determine the second network connection between the first device and the second device according to the second configuration of the set of parameters based on the second power consumption level. For example, the first device may determine the second configuration of the set of parameters based on the second power consumption level. For example, the first device may identify a configuration of the set of parameters that achieves the second power consumption level. For example, if the first device identified 10 W as the second power consumption level, the first device may identify a configuration of a set of parameters that achieves 10 W based on the power consumption table. In an example, the first device may establish/cause a third network connection between the first device and the second device according to the first configuration of the set of parameters based on a data throughput associated with the second network connection rising above a threshold.

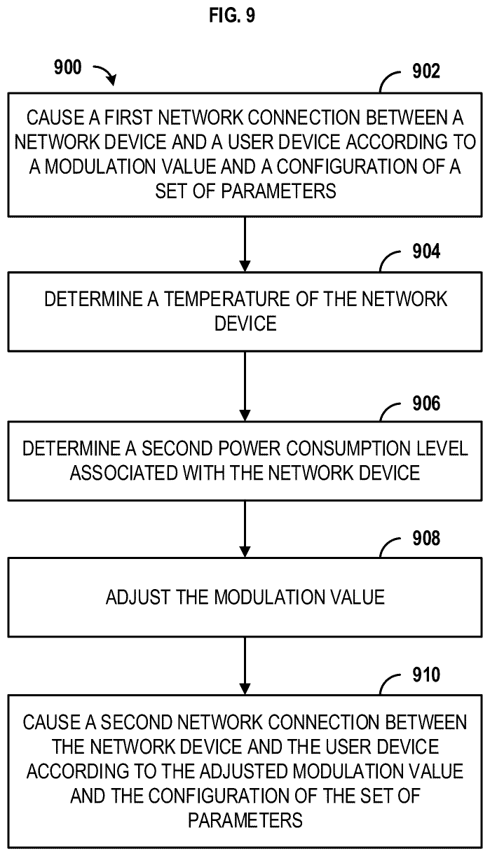

FIG. 9 shows a flowchart of an example method 900 for managing thermal efficiency of a network device. Method 900 may be implemented, for example, by a network device (e.g., network device 116, etc.). At step 902, a first network connection between a network device and a user device may be established/caused according to a modulation value and a configuration of a set of parameters that are associated with a first power consumption level associated with the network device. For example, a network device (e.g., network device 116, etc.) may establish/cause the first network connection between the network device and the user device according to the modulation value and the configuration of the set of parameters that are associated with the first power consumption level associated with the network device. The first configuration of the set of parameters may be based on a power consumption table. For example, a power consumption table may be stored on the network device. The power consumption table may comprise a plurality of configurations of the set of parameters that are associated with a plurality of power consumption levels associated with the network device. Each configuration of the plurality of configurations may be used to determine each power consumption level of the plurality of power consumption levels. The set of parameters may comprise one or more of a frequency band, a Wi-Fi standard, a bandwidth, a guard interval, or a number of antennas. The modulation value may be associated with a modulation coding scheme index.

At step 904, a temperature of the network device may be determined based on the first network connection. For example, the network device (e.g., network device 116, etc.) may determine the temperature based on the first network connection.

At step 906, based on the temperature of the network device, a second power consumption level associated with the network device may be determined. For example, the network device (e.g., network device 116, etc.) may determine the power consumption level associated with the network device based on the temperature of the network device. As an example, the second power consumption level associated with the network device may be determined based on the temperature rising above a threshold. For example, if the temperature rises above a temperature threshold, the network device may determine a second power consumption level that is lower than the first power consumption level. For example, if the first power consumption level was 23.5 W, the network device may identify 23 W as the second consumption level. By using a lower power consumption level, the network device may decrease the temperature of the network device below the temperature threshold. In an example, a fan of the network device may also be activated based on the temperature rising above the threshold. In an example, each configuration of the plurality of configurations of the power consumption table may be analyzed to determine a configuration that achieves the next power consumption level before switching to the second power consumption level.

At step 908, the modulation value may be adjusted based on the second power consumption level and based on the configuration of the set of parameters. For example, the network device (e.g., network device 116, etc.) may adjust the modulation value based on the second power consumption level and based on the configuration of the set of parameters. The adjusted modulation value may be associated with the modulation coding scheme index. As an example, the network device may change/adjust the modulation value of the modulation coding scheme index while maintaining the configuration of the set of parameters in order to achieve the second power consumption level.

At step 910, a second network connection between the network device and the user device may be established/caused according to the adjusted modulation value and the configuration of the set of parameters. For example, the network device (e.g., network device 116, etc.) may establish/cause the second network connection between the network device and the user device according to the adjusted modulation value and the configuration of the set of parameters.

In an example, a second temperature of the network device may be determined based on the second network connection. In one example, a third power consumption level may be determined based on the second temperature continuing to increase. The adjusted modulation value may be readjusted based the third power consumption level. A third network connection between the network device and the user device may be established/caused according to the readjusted modulation value and the configuration of the set of parameters. In another example, a third network connection between the network device and the user device may be established/caused according to the modulation value and the configuration of the set of parameters based on the second temperature of the network device falling below a second threshold.

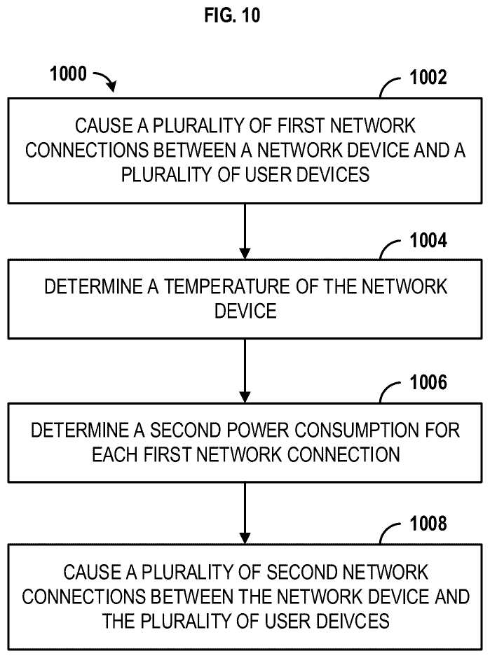

FIG. 10 shows a flowchart of an example method 1000 for managing thermal efficiency of a network device. Method 1000 may be implemented, for example, by a network device (e.g., network device 116, etc.). At step 1002, a plurality of first network connections between the network device and a plurality of user devices may be established/caused. For example, a network device (e.g., network device 116, etc.) may establish/cause the plurality of first network connections between the network device and the plurality of user devices. Each first network connection of the plurality of first network connections may be associated with a first configuration of a set of parameters associated with a first power consumption level. The plurality of first configurations of the set of parameters may be based on a power consumption table. For example, a power consumption table may be stored on the network device. The power consumption table may comprise a plurality of configurations of the set of parameters that are associated with a plurality of power consumption levels associated with the network device. Each configuration of the plurality of configurations may be used to determine each power consumption level of the plurality of power consumption levels. The set of parameters may comprise one or more of a frequency band, a Wi-Fi standard, a bandwidth, a modulation coding scheme (MCS) index, a guard interval, or a number of antennas.

At step 1004, a temperature of the network device may be determined based on the plurality of network connections. For example, the network device (e.g., network device 116, etc.) may determine the temperature based on the plurality of network connections. For example, each network connection of the plurality of network connections may contribute to a temperature increase of the network device.

At step 1006, based on the temperature of the network device, a second power consumption level for each first network connection may be determined. For example, the network device (e.g., network device 116, etc.) may determine the second power consumption level for each first network connection based on the temperature of the network device. As an example, the second power consumption level for each first network connection may be determined based on the temperature rising above a threshold. For example, if the temperature rises above a temperature threshold, the network device may determine a second power consumption level that is lower than the first power consumption level for each first network connection. For example, if a first power consumption level of a first one of the first network connections is 23.5, a first power consumption level of a second one of the first network connections is 23 W, and a first power consumption level of a third one of the first network connections is 18.5 W, the network device 116 may identify 22 W, 21 W, and 12.5 W as the second power consumption levels, respectively. By using a lower power consumption level for each first network connection, the network device may decrease the temperature of the network device below the temperature threshold. In an example, the network device may analyze each configuration of the plurality of configurations of the power consumption table for each of the first network connections to determine a configuration that achieves the next power consumption level for each of the first network connections before switching to the second power consumption level for each of the first network connections. In an example, a fan of the network device may also be activated based on the temperature rising above the threshold.

At step 1008, a plurality of second network connections between the network device and the plurality of user devices may be established/caused based on each second power consumption level of the plurality of second power consumption levels. For example, the network device (e.g., network device 116, etc.) may establish/cause the plurality of second network connections between the network device and the plurality of user devices. Each second network connection of the plurality of second network connections may be associated with a second configuration of the set of parameters associated with the corresponding second power consumption level of the plurality of second power consumption levels. The network device may determine the plurality of second configurations of the set of parameters based on each second power consumption level. For example, the network device may identify configurations of the set of parameters that achieve each second power consumption level. For example, if the second power consumption levels comprised 22 W, 21 W, and 12.5 W, respectively, the network device may identify configurations of the set of parameters that achieve 22 W, 21 W, and 12.5 W based on the power consumption table. As an example, the network device may identify the configurations of the set of parameters that include channels closest to the initial channels used to establish the initial network connections in order to avoid adjacent channel interference.

In an example, a second temperature of the network device may be determined based on the plurality of second network connections. In one example, a third power consumption level for each second network connection may be determined based on the second temperature continuing to increase. A plurality of third network connections between the network device and the plurality of user devices may be established/caused based each third power consumption level of the plurality of third power consumption levels. Each third network connection of the plurality of third network connections may be associated with a third configuration of the set of parameters associated with the corresponding third power consumption level of the plurality of third power consumption levels. In another example, a plurality of third network connections between the network device and the plurality of user devices may be established/caused based on the second temperature of the network device falling below a second threshold. Each third network connection of the plurality of third network connections may be associated with each first configuration of the set of parameters or each second configuration of the set of parameters.

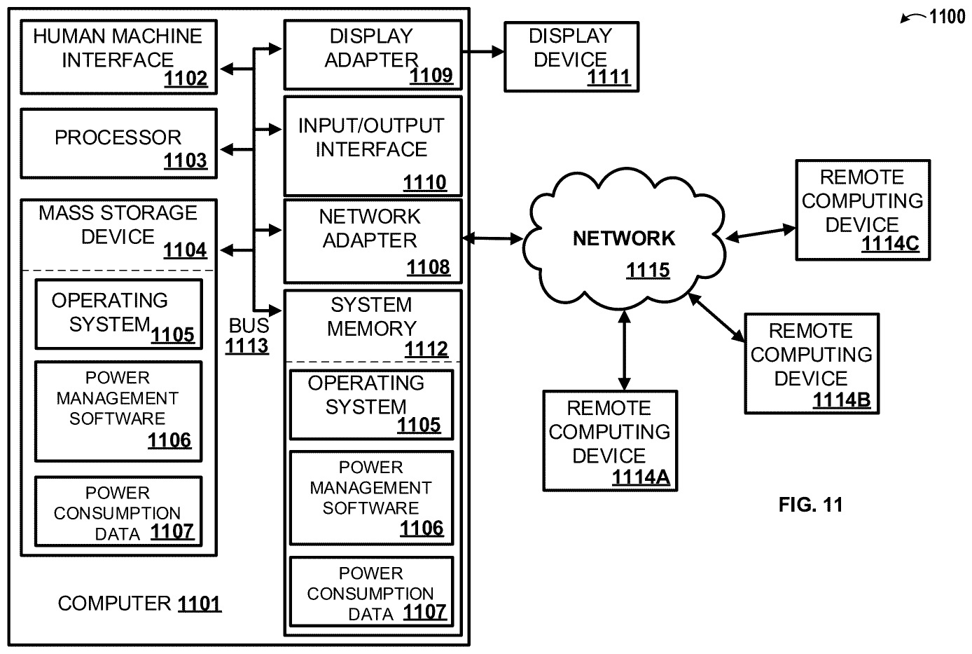

FIG. 11 is a block diagram illustrating an example computing device. The methods and systems can be implemented on a computer 1101 as illustrated in FIG. 11 and described below. By way of example, the one or more devices 102, the network device 116, and the computing device 104 of FIG. 1 can be a computer 1101 as illustrated in FIG. 11. Similarly, the methods and systems disclosed can utilize one or more computers to perform one or more functions in one or more locations. FIG. 11 is a block diagram illustrating an exemplary operating environment 1100 for performing the disclosed methods. This exemplary operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the exemplary operating environment 1100.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1101. The computer 1101 can comprise one or more components, such as one or more processors 1103, a system memory 1112, and a bus 1113 that couples various components of the computer 1101 including the one or more processors 1103 to the system memory 1112. In the case of multiple processors 1103, the system can utilize parallel computing.

The bus 1113 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and one or more of the components of the computer 1101, such as the one or more processors 1103, a mass storage device 1104, an operating system 1105, power management software 1106, power consumption data 1107, a network adapter 1108, system memory 1112, an Input/Output Interface 1110, a display adapter 1109, a display device 1111, and a human machine interface 1102, can be contained within one or more remote computing devices 1114A-1114C at physically separate locations, connected through buses of this form, in effect implementing a fully distributed system.

The computer 1101 typically comprises a variety of computer readable media. Exemplary readable media can be any available media that is accessible by the computer 1101 and comprises, for example and not meant to be limiting, both volatile and non-volatile media, removable and non-removable media. The system memory 1112 can comprise computer readable media in the form of volatile memory, such as random access memory (RAM), and/or non-volatile memory, such as read only memory (ROM). The system memory 1112 typically can comprise data such as power consumption data 1107 and/or program modules such as operating system 1105 and power management software 1106 that are accessible to and/or are operated on by the one or more processors 1103.

The computer 1101 can also comprise other removable/non-removable, volatile/non-volatile computer storage media. By way of example, the computer 1101 can comprise a mass storage device 1104 which can offer non-volatile storage of computer code, computer readable instructions, data structures, program modules, and other data for the computer 1101. For example, a mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, including by way of example, an operating system 1105 and power management software 1106. One or more of the operating system 1105 and power management software 1106 (or some combination thereof) can comprise elements of the programming and the power management software 1106. Power consumption data 1107 can also be stored on the mass storage device 1104. Power consumption data 1107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1115.

The user can enter commands and information into the computer 1101 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1103 via a human machine interface 1102 that is coupled to the bus 1113, but can be connected by other interface and bus structures, such as a parallel port, game port, an IEEE 1394 Port (also known as a Firewire port), a serial port, network adapter 1108, and/or a universal serial bus (USB).

A display device 1111 can also be connected to the bus 1113 via an interface, such as a display adapter 1109. It is contemplated that the computer 1101 can have more than one display adapter 1109 and the computer 1101 can have more than one display device 1111. For example, a display device 1111 can be a monitor, an LCD (Liquid Crystal Display), light emitting diode (LED) display, television, smart lens, smart glass, and/or a projector. In addition to the display device 1111, other output peripheral devices can comprise components such as speakers (not shown) and a printer (not shown) which can be connected to the computer 1101 via Input/Output Interface 1110. Any step and/or result of the methods can be output in any form to an output device. Such output can be any form of visual representation, including, but not limited to, textual, graphical, animation, audio, tactile, and the like. The display 1111 and computer 1101 can be part of one device, or separate devices.

The computer 1101 can operate in a networked environment using logical connections to one or more remote computing devices 1114A, 1114B, and 1114C. By way of example, a remote computing device 1114A-1114C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1101 and a remote computing device 1114A-1114C can be made via a network 1115, such as a local area network (LAN) and/or a general wide area network (WAN). Such network connections can be through a network adapter 1108. A network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components can reside at various times in different storage components of the computer 1101, and are executed by the one or more processors 1103 of the computer 1101. An implementation of power management software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
causing, by a network device, a first network connection between the network device and a user device according to a first configuration of a set of parameters associated with a first power consumption level associated with the network device;
determining, based on the first network connection, a temperature of the network device;
based on the temperature of the network device, determining a second power consumption level associated with the network device; and
causing, based on the second power consumption level, a second network connection between the network device and the user device according to a second configuration of the set of parameters.

2. The method of claim 1, wherein one or more of the first configuration of the set of parameters or the second configuration of the set of parameters are based on a power consumption table.

3. The method of claim 1, wherein the set of parameters comprise one or more of a frequency band, a Wi-Fi standard, a bandwidth, a modulation coding scheme index, a guard interval, or a number of antennas.

4. The method of claim 1, wherein a fan is activated based on the temperature of the network device.

5. The method of claim 1, wherein the second power consumption level is lower than the first power consumption level.

6. The method of claim 1, wherein the second configuration of the set of parameters comprises one or more of a same frequency band, a same modulation, a same guard interval, or a same number of antennas as the first configuration of the set of parameters.

7. The method of claim 1, further comprising determining, based on the second network connection, a second temperature of the network device.

8. The method of claim 7, further comprising:
determining, based on the second temperature continuing to increase, a third power consumption level; and
causing, based on the third power consumption level, a third network connection between the network device and the user device according to a third configuration of the set of parameters.

9. The method of claim 7, further comprising causing, based on the second temperature of the network device falling below a second threshold, a third network connection between the network device and the user device according to the first configuration of the set of parameters or the second configuration of the set of parameters.

10. A method comprising:
based on a temperature of a network device, determining, by the network device, a first power consumption level associated with a first network connection between the network device and a user device;
determining, based on a first configuration of a set of parameters associated with the first power consumption level, a second configuration of the set of parameters associated with a second power consumption level; and
causing a second network connection between the network device and the user device according to the second configuration of the set of parameters.

11. The method of claim 10, wherein one or more of the first configuration of the set of parameters or the second configuration of the set of parameters are based on a power consumption table.

12. The method of claim 10, wherein the set of parameters comprise one or more of a frequency band, a Wi-Fi standard, a bandwidth, a modulation coding scheme index, a guard interval, or a number of antennas.

13. The method of claim 10, wherein the second power consumption level is lower than the first power consumption level.

14. The method of claim 10, wherein the second configuration of the set of parameters comprises one or more of a same frequency band, a same modulation, a same guard interval, or a same number of antennas as the first configuration of the set of parameters.

15. A method comprising:
causing, by a first device, a first network connection between the first device and a second device according to a first configuration of a set of parameters associated with a first power consumption level associated with the first device;
based on a data throughput associated with the first network connection, determining a second power consumption level associated with the first device; and
causing, based on the second power consumption level, a second network connection between the first device and the second device according to a second configuration of the set of parameters.

16. The method of claim 15, wherein one or more of the first configuration of the set of parameters or the second configuration of the set of parameters are based on a power consumption table.

17. The method of claim 15, wherein the set of parameters comprise one or more of a frequency band, a Wi-Fi standard, a bandwidth, a modulation coding scheme index, a guard interval, or a number of antennas.

18. The method of claim 15, wherein based on the data throughput associated with the first network connection, determining the second power consumption level associated with the first device comprises based on the data throughput falling below a threshold, determining a second power consumption level that is lower than the first power consumption level.

19. The method of claim 15, wherein based on the data throughput associated with the first network connection, determining the second power consumption level associated with the first device comprises based on the data throughput rising above a threshold, determining a second power consumption level that is greater than the first power consumption level.

20. The method of claim 15, further comprising based on a data throughput associated with the second network connection rising above a threshold, causing a third network connection between the first device and the second device according to the first configuration of the set of parameters.
